(19) United States
(12) Patent Application Publication
(10) Pub. No.: US 2004/0117814 A1
(43) Pub. Date: Jun. 17, 2004

(54) Method and apparatus for determining positive audience response

(76) Inventor: Steven A. Roye, Santa Rosa, CA (US)

Correspondence Address: Mr. Walter J. Tencza Jr., Suite 3, 10 Station Place, Metuchen, NJ, 08840, US

(21) Appl. No.: 10/690,674

(22) Filed: Oct. 22, 2003

(51) Int. Cl. H04N 7/16; H04H 9/00

(52) U.S. Cl. 725/9; 725/13

(57) ABSTRACT

A method and apparatus for recording, measuring and calculating the percentage of positive audience response generated by any entertainment or presentation source involving an audience. The methods and apparatus described are intended as an evaluation tool to establish quantitative performance benchmarks and to objectively determine audience satisfaction based on readily identifiable and measurable positive audience response. A method is also provided to more objectively quantify the therapeutic effects of laughter.

### FIELD OF THE INVENTION

This invention relates to improved methods and apparatus concerning determining and analyzing the reactions of one or more test subjects of an audience to presentations or performances.

### BACKGROUND OF THE INVENTION

Typically in the prior art focus groups may be shown, for example, a proposed television program, and may be asked to indicate whether they have a favorable reaction to the television program or to parts of the television program. For example, a group of people may be shown a pilot television program and may press a button on an electronic device when they have a favorable reaction to what is occurring in the television program and may press another button to indicate when they have an unfavorable reaction.

### SUMMARY OF THE INVENTION

The present invention in one or more embodiments, provides a method comprising recording a first length of time of a first positive audience response of one or more test subjects to a presentation. The presentation may be a performance, such as a performance of a comedian, or may be an entertainment program, such as a television program or movie. In the present application the terms presentation and performance may be used interchangeably.

The first positive audience response may be audible, such as laughter, cheering, or applause, of one or more members of the audience. The method may further include displaying the length of time of the first positive audience response, for example, on a computer monitor. The method may be further comprised of determining an accumulated amount of time of positive audience response of one or more test subjects to a presentation, and determining a ratio of the accumulated amount of time of positive audience response divided by the length of total time of the presentation. The method may further include displaying the ratio on a computer monitor. The ratio may be displayed as a percentage of the total presentation time.

An accumulated amount of time of positive audience response of one or more test subjects for a first, second, and further minutes of the presentation may also be determined and displayed. An average amount of time of positive audience response of one or more test subjects per minute of the presentation may also be determined and displayed. The total number of positive audience responses of the one or more test subjects in a first, second, or further minutes of the presentation may be determined and displayed. An average number of positive audience responses of the one or more test subjects per minute of the presentation may be determined and displayed.

An embodiment is also provided including an apparatus comprising a performance timer for keeping track of the length of time of a performance or presentation, and a positive audience response timer for keeping track of the length of time of a positive audience response of an audience comprised of one or more test subjects, to one or more portions of the performance. The apparatus may be further comprised of a computer processor, and a computer monitor. The computer processor may display a running time of the performance timer and a running time of the positive audience response timer on the computer monitor. The computer processor may determine an accumulated positive audience response time from the one or more positive audience response times determined by the positive audience response timer.

The computer processor may determine a ratio of the accumulated positive audience response time versus a total performance time determined by the performance timer, and may display the ratio on the computer monitor. The computer processor may determine and display on the computer monitor an accumulated amount of time of positive audience response of the one or more test subjects for first, second, or further minutes of a presentation.

The computer processor may determine and display on the computer monitor an average amount of time of positive audience response of the one or more test subjects per minute of the performance. The computer processor may determine and display on the computer monitor the total number of positive audience responses of the one or more test subjects in a first, second, or further minutes of the performance. The computer processor may determine and display the average number of positive audience responses of the one or more test subjects per minute of the performance.

### BRIEF DESCRIPTION OF THE DRAWINGS

FIG. 1 shows an apparatus for use in accordance with an embodiment of the present invention;

FIG. 2 shows a flow chart of a method for use with the apparatus of FIG. 1 in accordance with an embodiment of the present invention; and

FIG. 3 shows a menu, which may be displayed on a computer monitor of the apparatus of FIG. 1 in accordance with an embodiment of the present invention.

### DETAILED DESCRIPTION OF THE DRAWINGS

The present invention provides several terms or expressions, which to some extent have been coined by this application. The definitions for these terms are as follows.

The term “Positive Audience Response” (PAR) means any positive or favorable response, typically audible, generated by an audience as a reaction to any entertainment or presentation source. This reaction primarily includes, but is not limited to laughter, cheering and applause. In the case of a non-comedic genre of entertainment or presentation, such as horror, PAR may include gasps, screams, etc. It is important to note that the definition of PAR is dependent upon the genre or style of entertainment or presentation engaged by the audience and the audible audience response usually associated with that genre or style. It is assumed that PAR (Positive Audience Response) accumulation and duration can be directly associated with the level of enjoyment or satisfaction created for the audience by the entertainment or presentation source as it relates to the audience expectations and expected optimal response from that source.

The term “PAR Index” means the percentage of accumulated “Positive Audience Response” in seconds or minutes in relation to the length of time in seconds or minutes of the entertainment or presentation source. The PAR index can vary widely depending upon the entertainment or presentation source context and content. For example, a situation comedy television program having a 20 PAR Index, would mean that for 20% of the entire television program a test subject or individual showed a positive audience response. Typically in the case of a comedy this would mean that the test subject was laughing, cheering, or applauding for 20% of the television program.

The PAR Index can be affected favorably or adversely by a number of factors associated with audience dynamics—size, seating arrangements, room acoustics, audience demographics, etc. Accommodation for these factors is typically beyond the scope of the evaluation methodology described.

“Performance” as used in this application typically means any entertainment or presentation source engaged by an audience. However, the term performance, as used to describe the methods and apparatus described herein, is not limited to solely to the common classifications associated with entertainment activities alone. Performance can be used to describe any activity via any medium that engages an audience and that can result in a measurable duration of audible positive audience response (PAR).

The term “Laugh Exposure Index” as used in the present application means the “PAR Index” as it relates specifically to the measurement of the duration of laughter by an audience during a performance. For example, if a test subject were laughing for 15% of the duration of a television program, then the “Laugh Exposure Index” would be 15 or 15%.

The term “PAR Seconds Each Minute” (PSEM) is a measurement of the accumulated seconds of positive audience response (PAR) measured in one-minute increments. For example, if a test subject has a positive response (such as laughing, cheering, or applauding) for ten seconds out of one minute then the PAR Seconds Each Minute (PSEM) would be ten seconds.

The term “Average PAR Seconds PER Minute” (APSPM) is the average number of seconds of positive audience response (PAR) per each minute in relation to the duration of the entertainment or presentation source evaluated. For example, if a television program is 22 minutes long and the total positive audience response is 11 minutes, the average PAR seconds per minute (APSPM) would be 30 seconds per minute (i.e. half the time).

The term “PAR Frequency Each Minute (PFEM)” is the number, not duration, of positive audience responses that occur in a single minute. For example, if someone laughs on two occasions during a single minute of a television program, then the “PAR Frequency each minute” for that minute of the television program would be two.

The term “Average PAR Frequency Per Minute” (APFPM) is the average number of positive audience responses that occur each minute in relation to the entire entertainment or presentation event. For example, if there were thirty positive audience responses during an entire television program and if the television program were thirty minutes long then the average par frequency per minute (APFPM) would be one.

The term “Words Per Minute Index (WPMI)” is the average number of words used per minute as it relates to the speech rate of the entertainment or presentation source and the duration of positive audience response (PAR) generated each minute. For example, a PAR Index of 25 would mean that 25% of the performance (or 15 seconds of each minute evaluated) showed positive audience response and 75% (or 45 seconds of each minute evaluated) were dedicated to the communication required during the performance to generate the positive audience response.

By design, entertainment and presentation sources intentionally and methodically illicit PAR as opposed to negative audience response or extended absence of any response. So, it can be assumed that negative audience response or prolonged absence of either PAR or the communication to illicit PAR is undesirable in almost all cases and in most cases is not a significant factor.

By determining the approximate rate of speech per minute used during the performance (accomplished most simply by counting the number of words spoken in 10 seconds and multiplying by 6), it is possible to determine the approximate number of words spoken used each second. For example, a speech rate of 150 words per minute (the average benchmark for WPM used spoken communication) would mean that 2.5 words are used each second for communicating during the performance. By multiplying the amount of non-PAR time in this example (45 seconds) by the approximate 2.5 words per second used in a speech rate of 150 words per minute (WPM), it can be determined that the performance source used approximately 90 words to generate a PAR of 15, resulting in a Word Per Minute Index of 90.

The term “Audience Satisfaction Index (ASI)” is a good PAR Index level as it relates to a particular entertainment or presentation source. For example, a good audience satisfaction index (ASI) for a stand-up comedian may be 40% while a good audience satisfaction index for a romantic comedy movie may be 5%.

The term “Audience” means a single test individual or group of individuals viewing, listening or otherwise engaged in an entertainment event or presentation.

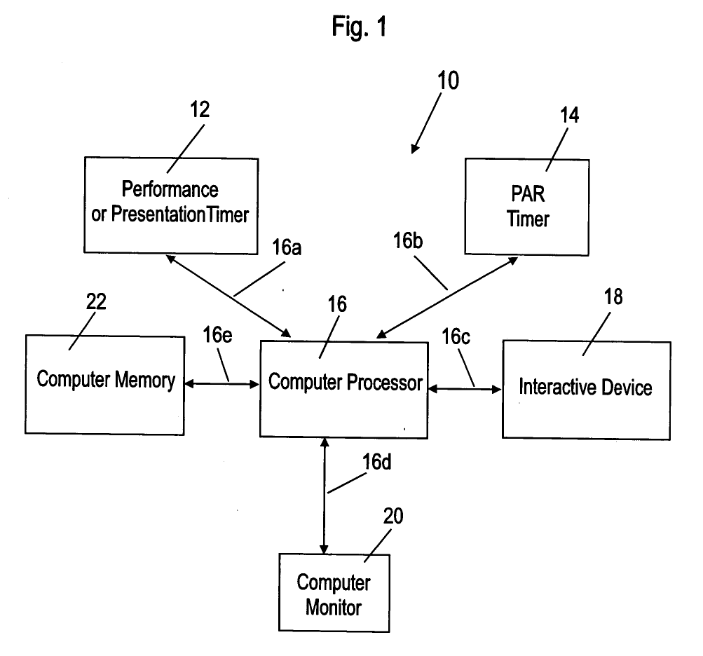

FIG. 1 shows an apparatus 10 in accordance with an embodiment of the present invention. The apparatus 10 is comprised of a computer processor 16 which is electronically connected to a performance or presentation timer 12, a positive audience response (PAR) timer 14, an interactive device 18, a computer monitor 20, and a computer memory 22 via communication lines 16a, 16b, 16c, 16d, and 16e, respectively. The communication lines 16a-e may be comprised of any type such as hardwired, wireless, fiber optic, etc. The interactive device 18 may be a computer mouse, a computer keyboard, or any other interactive device.

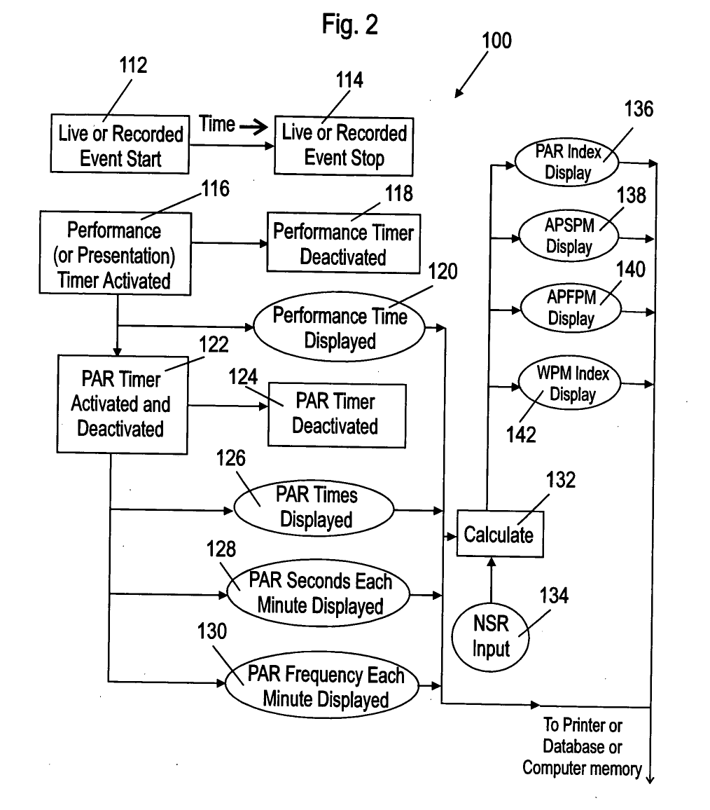

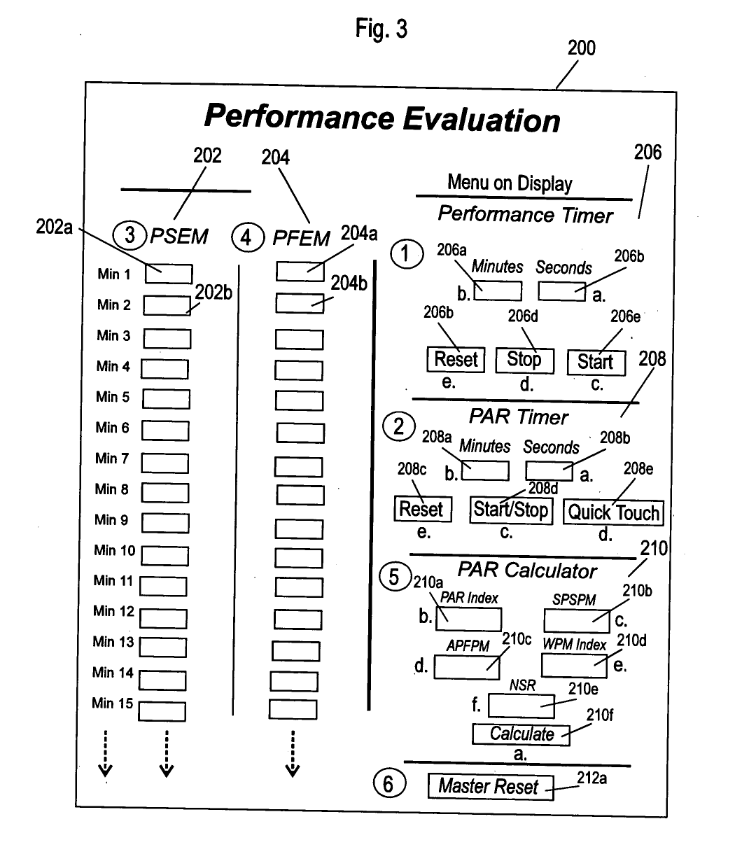

FIG. 2 shows a flow chart 100 of a method in accordance with an embodiment of the present invention for use with the apparatus 10 of FIG. 1. The flow chart 100 can be called a performance evaluation operational flow chart. The method of the flow chart 100 begins at step 112. At step 112 a live event, such as a concert, begins, or a recorded event, such as a tape of a concert, is played back from its beginning. At the time that the event begins, the performance timer 12 is activated, either automatically by the processor 16, or by an input through the interactive device 18 by an operator. The interactive device 18 may be comprised of a screen or menu 200 shown in FIG. 3, which may be displayed on the computer monitor 20 of FIG. 1. The computer monitor 20 may be an interactive device itself and may have a touch screen for allowing inputs to the processor 16. A user may activate the performance timer 12 by pressing the start Field 206e in the performance timer section 206 on the screen or menu 200 on the computer monitor 20. A user may deactivate the performance timer 12 by pressing the stop field 206d on a touch screen or display 200 on the computer monitor 20. When the performance timer 12 is deactivated, various PAR data is typically determined by the processor 16 and displayed by the computer monitor 20.

The live event proceeds or the recorded event is played for a certain period of time until the particular event is stopped at step 114.

At approximately the same time the live event starts or the recorded event playback starts, the performance timer 12 shown in FIG. 1 is activated by the computer processor 16 at step 116. A running time for the performance timer 12 is displayed in section 206 of screen or display 200 on the computer monitor 20. The performance timer 12 stays active for the same period of time that the live event or the playback of the recorded event continues.

After the performance timer 12 has been activated at step 116, the positive audience response (PAR) timer 14 will be activated by the processor 16 at the start of a positive audience response (such as an audible laugh) and deactivated by the processor 16 at the end of a positive audience response (such as the end of an audible laugh). The processor 16's control over the activation and deactivation of the PAR timer 14 may be controlled or influenced by inputs from an operator through interactive device 18 or computer monitor 20.

As the processor 16 and/or operator controls the input of the positive audience response (PAR) data, the PAR Seconds Each Minute (PSEM) and PAR Frequency Each Minute (PFEM) are provided automatically calculated by the computer processor 16. For an online, Internet-based application, the PAR Timer 14 can be activated with a button or field click on the screen, such as a click on field 208c of the PAR Timer section 208 on menu or display 200 of computer monitor 20, to begin recording, click again on field to 208c (i.e. toggle switch) to stop recording a positive audience response (PAR).

A mouse over function can also be provided through the interactive device 18, that allows the user to simply place a mouse cursor on an image or field such as field 208e to begin recording a positive audience response (PAR) and removing the mouse cursor from the image or field such as field 208e to stop recording a positive audience response (PAR), which may in some cases provide the highest accuracy of recording a positive audience response (PAR).

For a hand-held application, i.e. when the apparatus 10 or features of the apparatus 10 are incorporated into a handheld computing device, the PAR timer 14 can be activated with the depression of a button and deactivated when the button is released. In this case, field 208c, may be a button, or a field on a touch screen of a handheld device.

The time elapsed in the PAR timer 14 at the end of a positive audience response may be stored in the computer memory 22 by the computer processor 16.

At the end of a live performance or after a playback of a recorded performance has ended, the time elapsed on the performance or presentation timer 12, whose current running value is displayed in section 206, fields 206a and 206b, of display 200 may be stored in the computer memory 22 by the computer processor 16. At step 124 shown in FIG. 2, the processor 16 ensures that the PAR timer 14 whose current value is displayed in section 208 of display 200 is deactivated, if it was activated, and ensures that the PAR timer 14 will not be activated until the next live event is started or recorded playback is started. The total performance time may be displayed on computer monitor 20 in fields 206a and 206b of screen, display or menu 200 at step 120. Positive audience response times may be displayed on the computer monitor 20 in fields 208a and 208b at step 126. Positive Audience Response seconds each minute (PSEM) may be displayed on the computer monitor 20 in fields 202a and 202b, and further fields in colum 202 of display 200 at step 128. Positive Audience Response frequency each minute (PFEM) may be displayed on the computer monitor 20 in fields 204a and 204b, and further fields shown in column 204 at step 130.

At step 132 the processor 16 uses normal speech rate (NSR) Input from step 134, which may be entered by an operator via interactive device 18, to calculate the positive audience response (PAR) Index, APSPM, the APFPM, and the WPM. The PAR index, the APSPM, the APFPM, and the words per minute index (WPM) may be automatically determined by the processor 16 when the performance timer 12 stops and this data may be displayed on the computer monitor 16 at steps 136, 138, 140, and 142.

FIG. 3 shows a menu or display 200 which may be displayed on the computer monitor 20 in accordance with an embodiment of the present invention. The menu or display 200 includes columns 202, 204, and sections 206, 208, 210, and 212. Column 202 shows the PSEM, column 204 shows the PFEM, section 206 shows aspects of the performance timer, section 208 shows aspects of the PAR Timer, section 210 shows aspects of the PAR Calculator. Section 212 shows the Master reset.

In FIG. 3, the performance timer section 206 includes a minutes display 206a, which shows a running time of the elapsed number of minutes for which the performance has taken place, which may be accurate to the tenth of a minute. The performance timer section 206 also includes a seconds display 206b, which shows a running time of the elapsed whole number of seconds for which the performance has taken place.

Section 206 of the display 200 also includes a reset button or field 206c which resets the performance timer 12 to zero, a stop button or field 206d which deactivates the performance timer 12, and a start button or field 206e which activates the performance timer 12 and other functional elements in the apparatus 10.

Section 208 of the display 200 refers to the PAR timer 14. Section 208 includes field 208a, which shows the elapsed number of minutes typically accurate to the tenth of a minute, for which the current positive audience response has been occurring. Field 208b shows the elapsed number of seconds typically in seconds and in milliseconds for which the current positive audience response has been occurring.

Section 208 of the display 200 also includes a reset button or field 208c which resets the PAR timer 14 to zero, a start/stop button or field 208d which activates or deactivates, respectively, the PAR timer 14, and a quick touch button or field 208e which typically applies to online, internet-based applications and independent computer software applications. The quick touch button or field 208e may have the same functionality as the start/stop button or field 208d, but may utilize a common computer mouse over function previously described.

The PAR timer 14 is used to record the positive audience response PAR generated by the entertainment or presentation source during the performance. The PAR timer 14 typically will not be activated by the processor 16 unless the performance timer 12 has been activated.

Column 202 shows the PAR Seconds Each Minute (PSEM) display. Column 202 displays on the computer monitor 20 positive audience response (PAR) seconds accumulated each minute based on the use of the PAR Timer 14 to record PAR. There is no limit to the number of minute-by-minute displays of PAR seconds each minute and this may be relative to the duration of the performance being evaluated. The field 202a, for example, may include a number of seconds of positive audience response (PAR) during a first minute of a performance. Similarly the field 202b may include a number of seconds of positive audience response (PAR) during a second minute of a performance.

Column 204 shows the PAR Frequency Each Minute (PFEM) display. Column 204 displays the number of PAR events that occur in a single particular minute based on a simple counting function associated with the number of times the PAR timer 14 is activated each minute via the start/stop button or field 208d. For example, field 204a may show the number “1” to indicate that there was one positive audience response (PAR) during a first minute of a performance. Similarly, field 204b may show the number “2” to indicate that there were two positive audience responses (PARs) during a second minute of a performance.

The section 210 is the PAR calculator section, whose functions may be performed by the processor 16 of FIG. 1. The PAR calculator section 210 shows calculation results on the display 200 on the computer monitor 20. The PAR calculator section 210 includes a calculate button 210f which when pressed or clicked causes the processor 16 to initiate and complete the calculation functions necessary to determine the PAR Index, Average PAR Seconds Per Minute, and Words Per Minute Index (WPMI typically requires NSR input for determination). The calculate button 210f may be activated at any time during the evaluation to display the PAR Calculator function displays such as displays in section 210a, 210b, 210c, and 210d as well as any of the other displays on the display 200 in FIG. 3.

The section 210 includes a PAR Index field 210a. Once the Calculate button 210f is activated, the PAR Index value is displayed in a whole number in the PAR index field 210a, based on simple division of the seconds of accumulated for the particular positive audience response (PAR) by the seconds of total performance time elapsed or evaluated multiplied by one hundred. The result is an index number that represents the percentage of the performance that resulted in positive audience response (PAR).

The section 210 also includes an Average PAR Seconds Per Minute (APSPM) field 210b. The field 210b displays the average of the values displayed in the PAR Seconds Each Minute (PSEM) display in column 202 as accumulated by use of the PAR Start/Stop button 208d.

The section 210 also includes an Average PAR Frequency Per Minute (APFPM) field 210c. The field 210c displays the average of the values displayed in the PAR Frequency Each Minute (PFEM) in column 204 as accumulated by use of the PAR start/stop button or field 208d.

The section 210 also includes a words Per Minute (WPM) Index field 210d. The field 210d displays the average number of words actually spoken during a performance based on calculation of the non-PAR time, determination of the words per second used and multiplying these values as previously described.

The section 210 also includes a Normal Speech Rate (NSR) Input field 210e. The field 210e shows a whole number value, which is provided by the apparatus 10 user, through for example, interactive device 18 of FIG. 1. The NSR input field 210 represents the usual or customary average number of words used per minute during the performance when positive audience response (PAR) is absent. This value is used in the calculation of the words per minute index, which is displayed in field 210d.

It is common knowledge that while an entertainment or presentation source is speaking or communicating to an audience, zero or minimal positive audience response (PAR) occurs. When PAR occurs, the entertainment or presentation source must discontinue speaking or communicating. In essence, PAR and the communication or actions that generate PAR are two separate and measurable events.

Using the Normal Speech Rate Input by the apparatus 10 user, the Words Per Minute Index can be calculated by using the following formula:

$$\frac{( 60 minus Average PAR Seconds Each Minute )}{( 60 / Normal Speech Rate )}$$

The numerator in this formula determines the number of seconds used for communication by the entertainment or presentation source by subtracting the duration of PAR. The denominator in this formula determines the approximate number of words spoken each second. The Word Per Minute Index to be displayed in field 210d is determined by dividing the duration of non-PAR seconds by the number of words spoken each second.

This functionality is of particular interest to, but not limited to, professional comedians who must command a high PAR and high APFPM by using a minimum number of words each minute to attain the desired audience response. Simply put, this function provides an indicator of wordiness by the entertainment or presentation source, which limits the amount of PAR that can be achieved. Absence of the NSR input does not affect the calculation or display of the remaining calculations.

Finally the master reset button or field 212a resets all apparatus 10 functions to zero.

This present invention in one or more embodiments is intended as an evaluation tool to augment current methods used to measure or determine audience satisfaction. It is also intended as a tool to provide a quantifiable benchmark for performance improvement as it relates to a particular entertainment or presentation source.

It is assumed that the level of positive audience response (“PAR”) expressed by an audience is directly related to the satisfaction experienced by that audience, relative to any particular entertainment or presentation source.

The establishment of a positive audience response (PAR) Index using an apparatus in accordance with one or more embodiments of the present invention is not typically not dependent on subjective analysis or memory recall by an audience member and provides an accurate indication of the positive audience response (PAR) as it is happening or while it happened during any event or presentation that engages an audience.

Entertainment or presentation sources that can benefit from establishment of a quantifiable benchmark index for quality improvement standards, include, but are not limited to:

(1) Comedic Entertainers

(2) Speakers

(3) Musicians

(4) Instructors and Trainers

(5) Television programming executives

(6) Sales presenters

(7) Entertainment Agents and Booking Professionals

(8) Politicians

(9) Advertising and Marketing professionals

(10) Movie production organizations

(11) Television commercial production

(12) Any entertainment or presentation source that communicates with the spoken word to an audience or creates an audible positive audience response (PAR) in the process of engaging an audience.

The positive audience response (PAR) Index method in accordance with one or more embodiments of the present invention can also be applied to medical research. There is abundant and significant documentation available regarding the positive biological and therapeutic affects of laughter, most prolifically pursued by the Norman Cousins Research Center at the University of California Los Angeles.

However, the current research focuses on the biological effects based on an individual's exposure time to a performance that generates laughter, as opposed to determining the biological effects based the actual accumulated duration of laughter generated by the performance.

Using the Laugh Exposure Index, it is possible to quantify more precisely the amount or duration of laughter and correlate that exposure more accurately with resulting biological changes that occur as a result of laughing. In essence, this methodology provides a means to more accurately determine “laughter dose” based on actual laughter duration that correlates directly to a quantifiable range of resulting biological effects as evidenced by common blood testing methodologies and procedures.

The ultimate accuracy of the Positive Audience Response (PAR) Index and other functions described herein are dependent upon the skill of the end user to record PAR. To further verify the accuracy of PAR measurement, multiple end users can be used to record PAR to provide an average of the results.

The configuration of the menu or display 200 in FIG. 3 is ergonomically designed for a right-handed end user. The menu or display 200 can be easily configured to accommodate a left-handed end user by simply reversing the layout. This feature is incorporated to ensure further ease of use and to increase the accuracy of recoding positive audience response (PAR) by the end user.

Supplemental data can be entered into the computer processor 16 and/or the computer memory 22 along with the positive audience response (PAR) data. The supplemental data may include: date of event, name of event, audience size, and audience demographics.

The diagram of the menu or display 200 provided in FIG. 3 represents a model which may be used for an online, Internet-based version of the invention or as provided as an independent, computer-based software product. This presentation may include additional desired data desired by the end user conducting an evaluation as previously described.

A portable hand-held version of the apparatus 10 typically will incorporate the same functionality with a digital presentation using established and available digital technology via an open source.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising
recording a first length of time of a first positive audience response of one or more test subjects to a presentation.

2. The method of claim 1 wherein
the presentation is a performance.

3. The method of claim 1 wherein
first positive audience response is audible.

4. The method of claim 1 further comprising
displaying the length of time.

5. The method of claim 1 further comprising
determining an accumulated amount of time of positive audience response of one or more test subjects to a presentation;
determining a ratio of the accumulated amount of time of positive audience response divided by the length of total time of the presentation;
and displaying the ratio on a computer monitor.

6. The method of claim 5 wherein
the ratio is displayed as a percentage of the total time of the presentation.

7. The method of claim 1 wherein
the first positive audience response is comprised of laughter of the one or more test subjects.

8. The method of claim 1 wherein
the accumulated amount of time of positive audience response is comprised of an accumulated amount of time of laughter of the one or more test subjects.

9. The method of claim 1 further comprising
determining and displaying an accumulated amount of time of positive audience response of one or more test subjects for a first minute of the presentation.

10. The method of claim 9 further comprising
determining and displaying the accumulated amount of time of positive audience response of one or more test subjects for a second minute of a presentation.

11. The method of claim 1 further comprising
determining and displaying an average amount of time of positive audience response of one or more test subjects per minute of the presentation.

12. The method of claim 1 further comprising
determining and displaying the total number of positive audience responses of the one or more test subjects in a first minute of the presentation.

13. The method of claim 12 further comprising
determining and displaying the total number of positive audience responses of the one or more test subjects in a second minute of the presentation.

14. The method of claim 1 further comprising
determining and displaying the average number of positive audience responses of the one or more test subjects per minute of the presentation.

15. An apparatus comprising
a performance timer for keeping track of the length of time of a performance;
a positive audience response timer for keeping track of the length of time of a positive audience response of an audience comprised of one or more test subjects, to one or more portions of the performance;
a computer processor;
and a computer monitor;
wherein the computer processor displays a running time of the performance timer and a running time of the positive audience response timer on the computer monitor.

16. The apparatus of claim 15 wherein
the computer processor determines an accumulated positive audience response time from one or more positive audience response times determined by the positive audience response timer;
the computer processor determines a ratio of the accumulated positive audience response time versus a total performance time determined by the performance timer;
and wherein the computer processor displays the ratio on the computer monitor.

17. The apparatus of claim 16 wherein
the ratio is displayed as a percentage.

18. The apparatus of claim 15 wherein
the positive audience response is comprised of laughter of the one or more test subjects in the audience.

17. The apparatus of claim 16 wherein
the accumulated positive audience response time is comprised of an accumulated amount of time of laughter of the one or more test subjects.

18. The apparatus of claim 15 wherein
the computer processor determines and displays on the computer monitor an accumulated amount of time of positive audience response of the one or more test subjects for a first minute of the performance.

19. The apparatus of claim 18 wherein
the computer processor determines and displays on the computer monitor the accumulated amount of time of positive audience response of one or more test subjects for a second minute of the performance.

20. The apparatus of claim 15 wherein
the computer processor determines and displays on the computer monitor an average amount of time of positive audience response of the one or more test subjects per minute of the performance.

21. The apparatus of claim 13 wherein
the computer processor determines and displays on the computer monitor the total number of positive audience responses of the one or more test subjects in a first minute of the performance.

22. The apparatus of claim 21 wherein
the computer processor determines and displays on the computer monitor the total number of positive audience responses of the one or more test subjects in a second minute of the performance.

23. The apparatus of claim 15 wherein
the computer processor determines and displays the average number of positive audience responses of the one or more test subjects per minute of the performance.

24. The apparatus of claim 15 wherein
the positive audience response is audible.
